(19) United States
(12) Patent Application Publication
(10) Pub. No.: US 2002/0121759 A1
(43) Pub. Date: Sep. 5, 2002

(54) Expandable wheel Structure

(76) Inventor: Shou-Mao Chen, Taichung Hsien (TW)

Correspondence Address: HARRISON & EGBERT, 412 MAIN STREET, 7TH FLOOR, HOUSTON, TX, 77002, US

(21) Appl. No.: 09/788,861

(22) Filed: Feb. 21, 2001

(51) Int. Cl. B60G 1/00

(52) U.S. Cl. 280/124.125; 280/124.1

(57) ABSTRACT

A wheel structure comprises a wheel frame and an action device enabling wheels to be moved into wheel slots of the wheel frame to protect the wheels against impact. The action device comprises two shock-absorbing members in contact with axles on which the wheels are mounted.

### FIELD OF THE INVENTION

The present invention relates generally to a luggage, and more particularly to an expansible wheel of the luggage.

### BACKGROUND OF THE INVENTION

The conventional luggage wheel is generally defective in design in that it is vulnerable to damage which is caused by impact. As the conventional luggage is moved around on the surface or transported by the carrier, the luggage wheel is prone to damage.

### SUMMARY OF THE INVENTION

The primary objective of the present invention is to provide a luggage wheel which can be extracted and retracted, so as to prolong the service life span of the luggage wheel.

In keeping with the principle of the present invention, the foregoing objective of the present invention is attained by a luggage wheel structure comprising a wheel frame, an action device, and a plurality of shock-absorbing members. The wheel frame is used to house two wheels which can be extracted and retracted, thanks to the action device. The wheels are further protected by the shock-absorbing members.

### BRIEF DESCRIPTION OF THE DRAWINGS

FIG. 1 shows a perspective view of the luggage wheel structure of the present invention.

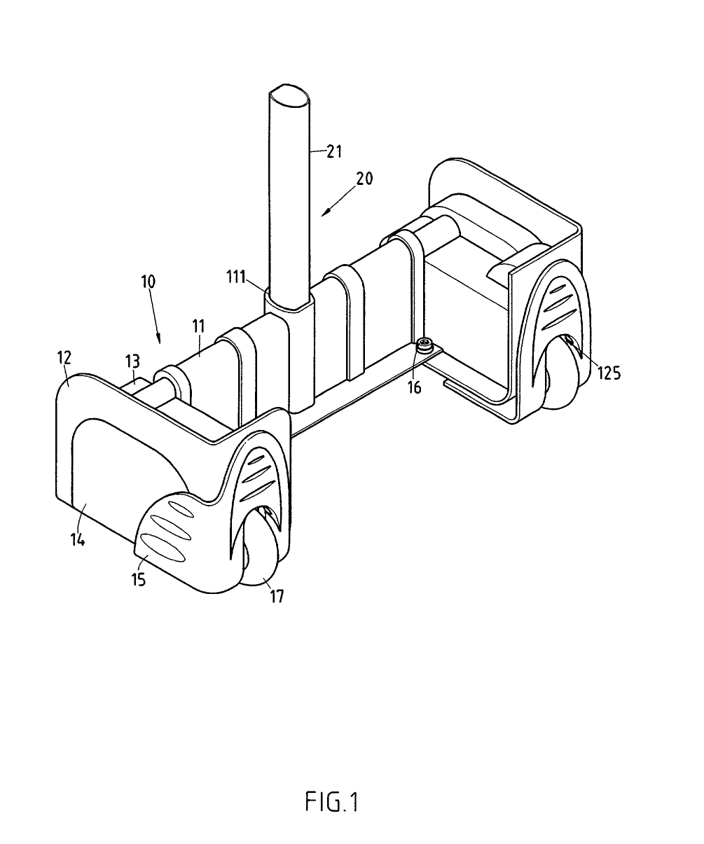

FIG. 2 shows an exploded view of the luggage wheel structure of the present invention.

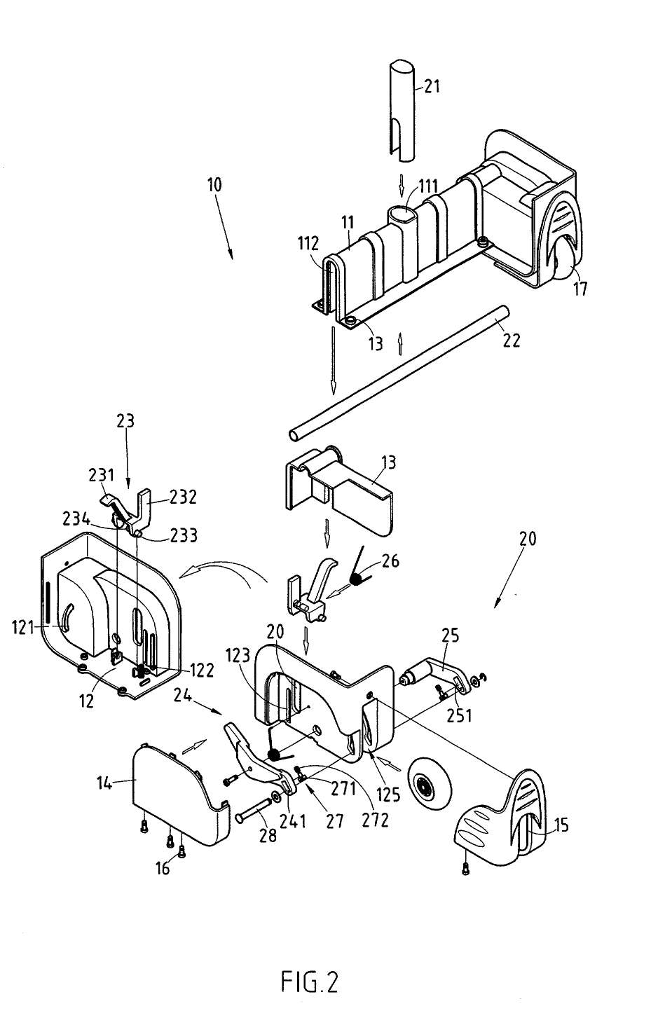

FIG. 3 shows a schematic view of the present invention in action.

FIG. 4 shows another schematic view of the present invention in action.

FIG. 5 shows still another schematic view of the present invention in action.

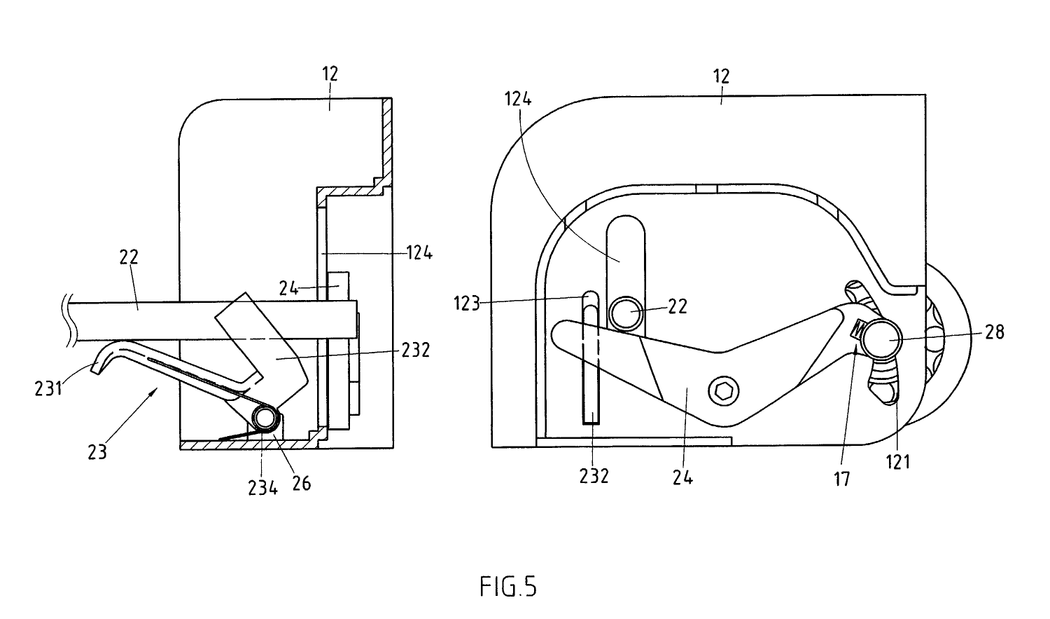

FIG. 6 shows a schematic view of the present invention in conjunction with a luggage shell.

### DETAILED DESCRIPTION OF THE INVENTION

As shown in all drawings provided herewith, a luggage wheel structure embodied in the present invention is designed for use in a luggage 29 and is formed of a wheel frame 10 and an action device 20.

The wheel frame 10 comprises a connection member 11, two lower covering members 12, two upper covering members 13, two side covering members 14, and two front covering members 15. The two lower covering members form jointly a wheel slot 125 to accommodate a wheel 17, a wheel guide hole 121, an urging hole 123, a position-confining hole 124, and a pivoting unit 122 for pivoting the action device 20. The lower covering members 12, the upper covering members 13, the side covering members 14, the front covering members 15 are fastened together by a plurality of screws 16. The connection member 11 is provided at both ends with a locating hole 113 for fastening with the two lower covering members 12 by a plurality of screws 16. The connection member 11 is further provided with a rod slot 112 and a through hole 111 for fastening with the component parts of the action device 20. The wheel frame 10 is provided with a plurality of receiving spaces for receiving the component parts of the action device 20.

The action device 20 comprises an action rod 21, a press rod 22, two urging members 23, two drawing members 25, two actuation members 24, two shock-absorbing members 27, two elastic elements 26, and two axles 28. The urging members 23 are provided with a handle 231, an urging block 232, a pivoting block 233, and an elastic locating block 234. The pivoting block 233 is pivoted with the pivoting unit 122 of the lower covering members 12 of the wheel frame 10. The elastic elements 26 are located by the elastic locating block 234. The urging block 232 urges the actuation member 24 via the urging hole 123 of the lower covering member 12. The press rod 22 is received in the rod slot 112 of the connection member 11 such that both ends of the press rod 22 press against the handles 231 of the two urging members 23. The action rod 21 is received in the through hole 111 of the connection member 11 such that the action rod 21 is in contact with the press rod 22. One actuation member 24 is disposed in the outer side of the lower covering member 12. One drawing member 25 is disposed in the inner side of the lower covering member 12 for mounting a wheel 17 in conjunction with one elastic element 26 and one axle 28. The actuation member 24 is provided with a shock-absorbing slot 241, whereas the drawing member 25 is provided with a shock-absorbing slot 241, whereas the drawing member 25 is provided with a shock-absorbing slot 251. The shock-absorbing slots 241 and 251 are intended to accommodate the two shock-absorbing members 27.

The shock-absorbing members 27 are formed of a spring 271 and a press block 272. The shock-absorbing members 27 are disposed in the shock-absorbing slots 241 and 251 of the actuation member 24 and the drawing member 25 such that the shock-absorbing members 27 are in contact with the axles 28.

The through hole 111 and the rod slot 112 of the connection member 11 of the wheel frame 10 are perpendicular to each other.

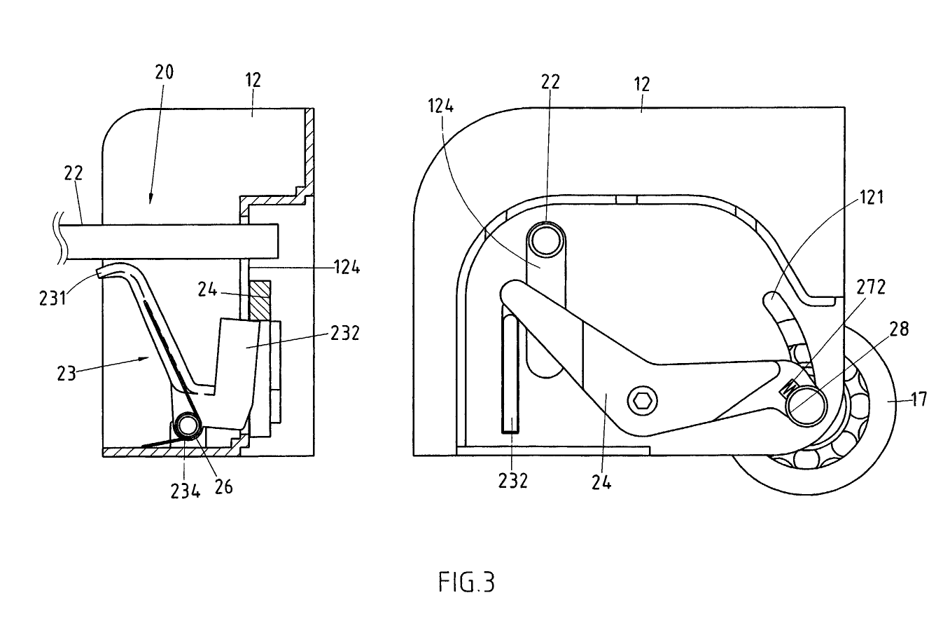

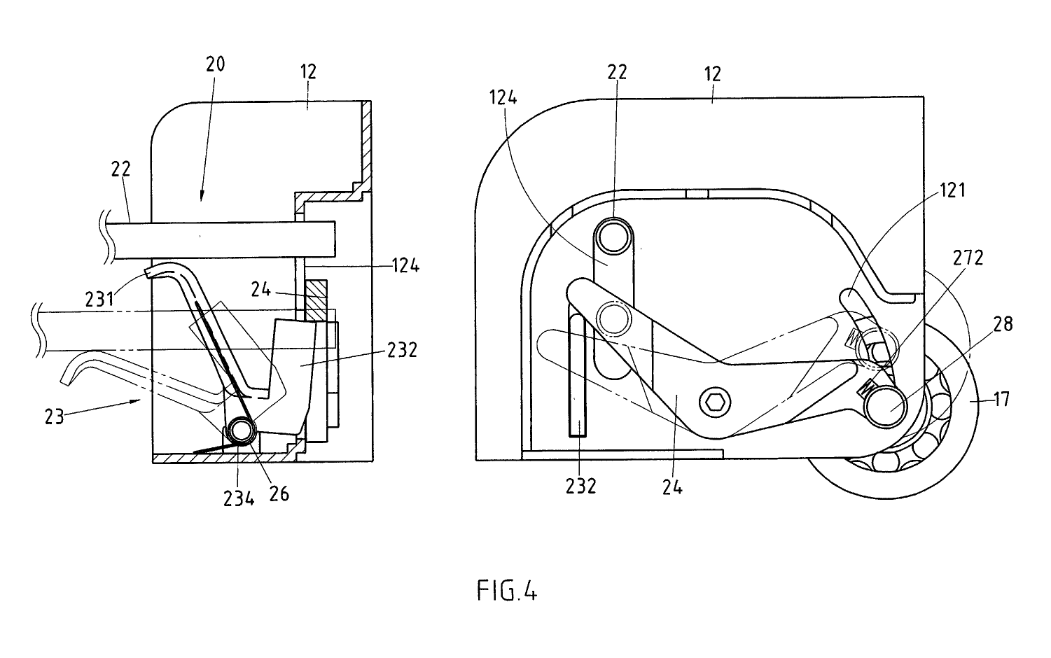

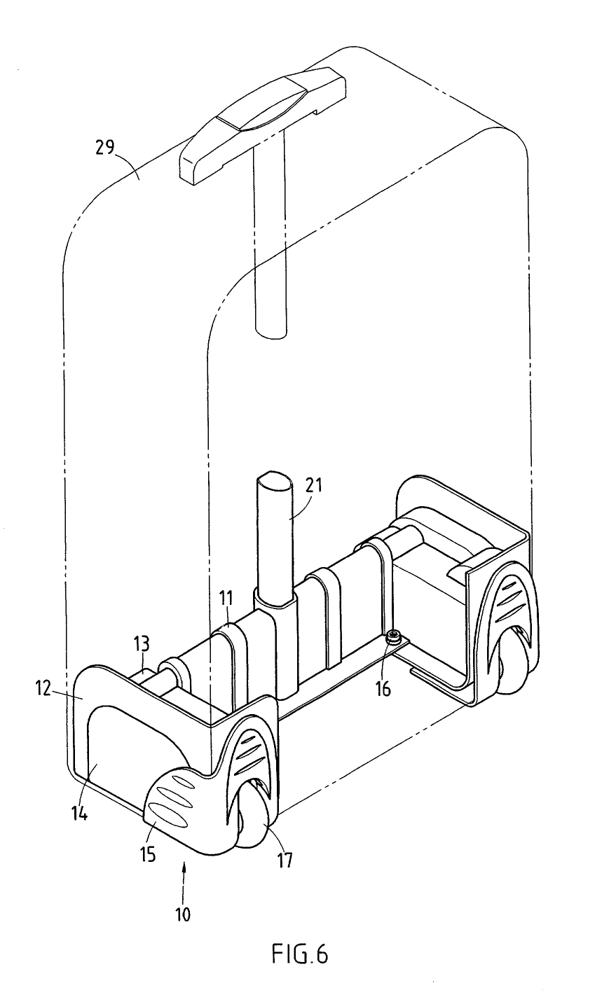

As shown in FIG. 6, the action rod 21 is fastened with a pull rod of the luggage 29. As the pull rod is pressed, the action rod 21 is forced to press the press rod 22, thereby causing both ends of the press rod 22 to actuate the handles 231 of the two urging members 23 to move. As a result, the urging block 232 moves to the outer side of the lower covering member 12 via the urging hole 123. In the meantime, the two actuation rods 24 are actuated by the press rod 22 to turn an angle so as to cause the wheel 17 to be retracted into the wheel slot 125 of the lower covering members 12. The wheel 17 is thus protected in the wheel slot 125. In addition, the wheel 17 is further protected by the shock-absorbing member 27 which is in contact with the axle 28 on which the wheel 17 is mounted. As shown in FIGS. 3 and 4, the press block 272 of the shock-absorbing member 27 is in contact with the axle 28.

What is claimed is:

1. A wheel structure comprising:
a wheel frame formed of a plurality of covering members and provided with a plurality of receiving spaces; and
an action device disposed in said receiving spaces of said wheel frame such that a wheel is acted on by said action device to move into one of said receiving spaces.

2. The wheel structure as defined in claim 1, wherein said wheel frame comprises a connection member, two lower covering members, two upper covering members, two side covering members, and two front covering members, said two lower covering members forming jointly a wheel slot to accommodate a wheel, a wheel guide hole, an urging hole, a position-confining hole, and a pivoting unit, said lower covering members, said upper covering members, said side covering members, and said front covering members being fastened together by a plurality of fastening screws, said connection member being provided at two ends thereof with a locating hole for fastening with said two lower covering members in conjunction with a plurality of screws, said connection member being further provided with a rod slot and a through hole.

3. The wheel structure as defined in claim 2, wherein said action device comprises an action rod, a press rod, two urging members, two drawing members, two actuation members, two shock-absorbing members, two elastic elements, and two axles, said action rod being located in said through hole of said connection member, said press rod being received in said rod slot such that said press rod is in contact with one end of said action rod, said urging members being provided with a handle, an urging block, a pivoting block, and an elastic locating block, said pivoting block being pivoted with said pivoting unit of said lower covering members of said wheel frame, said elastic elements being located by said elastic locating block, said urging block urging said actuation member via said urging hole of said lower covering member, said press rod being received in said rod slot of said connection member such that both ends of said press rod press against said handles of said two urging members, said actuation members being disposed in an outer side of said lower covering members, said drawing members being disposed in an inner side of said lower covering members, said axles being provided with a wheel mounted thereon in conjunction with said elastic element, said actuation members provided with a slot for receiving one of said two shock-absorbing members, said drawing members provided with a slot for receiving other one of said two shock-absorbing members.

4. The wheel structure as defined in claim 3, wherein said shock-absorbing members are formed of a spring and a press block whereby said press block is in contact with said axle.

5. The wheel structure as defined in claim 2, wherein said rod slot and said through hole of said connection member are perpendicular to each other.
